(19) United States
(12) Patent Application Publication
(10) Pub. No.: US 2024/0406949 A1
(43) Pub. Date: Dec. 5, 2024

(54) METHOD FOR WIRELESS COMMUNICATION, AND DEVICES

(71) Applicant: GUANGDONG OPPO MOBILE TELECOMMUNICATIONS CORP., LTD., Dongguan (CN)

(72) Inventors: Boren GUO, Dongguan (CN); Yali GUO, Dongguan (CN)

(21) Appl. No.: 18/806,226

(22) Filed: Aug. 15, 2024

Related U.S. Application Data
(63) Continuation of application No. PCT/CN2022/080965, filed on Mar. 15, 2022.

(51) Int. Cl. H04W 72/12

(52) U.S. Cl. CPC H04W 72/12

(57) ABSTRACT

Provides is a method for wireless communication. The method is applicable to a core network device. The method includes: determining first information of each of a plurality of data sets; and transmitting the first information of each of the plurality of data sets to an access network device; wherein the first information of each of the plurality of data sets is configured to determine importance and/or an association relationship of the plurality of data sets, such that the access network device is capable of scheduling air interface resources based on the importance and/or the association relationship of the plurality of data sets.

### CROSS-REFERENCE TO RELATED APPLICATION

This application is a continuation application of International Application No. PCT/CN2022/080965, filed Mar. 15, 2022, the entire disclosure of which is incorporated herein by reference.

### TECHNICAL FIELD

Embodiments of the present disclosure relate to the technical field of communications, and in particular, relate to a method for wireless communication, and a device thereof.

### BACKGROUND

Video coding techniques are involved in video transmission scenarios such as augmented reality (AR), virtual reality (VR), or cloud gaming. The video coding techniques typically include coding techniques based on intra-frame prediction and inter-frame prediction. Based on this, there exist intra-coded frames (I-frames), forward predictive-coded frames (P-frames), and bi-directional interpolated prediction frames (B-frames). Therefore, there is a dependency relationship between video frames. For example, a reference frame of a P-frame is its previous I-frame or P-frame.

### SUMMARY

Embodiments of the present disclosure provide a method for wireless communication, and device thereof.

According to some embodiments of the present disclosure, a method for wireless communication is provided. The method is applicable to a core network device, and the method includes: determining first information of each of a plurality of data sets; and transmitting the first information of each of the plurality of data sets to an access network device; wherein the first information of each of the plurality of data sets is configured to determine importance and/or an association relationship of the plurality of data sets, such that the access network device is capable of scheduling air interface resources based on the importance and/or the association relationship of the plurality of data sets.

According to some embodiments of the present disclosure, a core network device is provided. The device includes a processor and a memory. The memory is configured to store at least one computer program. The processor, when loading and running the at least one computer program stored in the memory, is caused to perform the method as described above.

According to some embodiments of the present disclosure, an access network device is provided. The device includes a processor and a memory storing at least one computer program therein, wherein the processor, when loading and running the at least one computer program stored in the memory, is caused to perform: receiving first information of each of a plurality of data sets from a core network device; determining importance and/or an association relationship of the plurality of data sets based on the first information of each of the plurality of data sets; and scheduling air interface resources based on the importance and/or the association relationship of the plurality of data sets.

### BRIEF DESCRIPTION OF DRAWINGS

FIG. 1 exemplarily illustrates a schematic diagram of a communication system 100 to which the present disclosure is applicable;

FIG. 2 is a schematic diagram of a QoS model for a 5G network;

FIG. 3 exemplarily illustrates a schematic diagram of a user-plane protocol stack;

FIG. 4 is an interaction flowchart of a method for wireless communication according to some embodiments of the present disclosure;

FIG. 5 is an interaction flowchart of another method for wireless communication according to some embodiments of the present disclosure;

FIG. 6 is a schematic diagram of a data set according to some embodiments of the present disclosure;

FIG. 7 is a schematic diagram of another data set according to some embodiments of the present disclosure;

FIG. 8 is an interaction flowchart of yet another method for wireless communication according to some embodiments of the present disclosure;

FIG. 9 is an interaction flowchart of still yet another method for wireless communication according to some embodiments of the present disclosure;

FIG. 10 is an interaction flowchart of still yet another method for wireless communication according to some embodiments of the present disclosure;

FIG. 11 is an interaction flowchart of still yet another method for wireless communication according to some embodiments of the present disclosure;

FIG. 12 is an interaction flowchart of still yet another method for wireless communication according to some embodiments of the present disclosure;

FIG. 13 is an interaction flowchart of still yet another method for wireless communication according to some embodiments of the present disclosure;

FIG. 14 is a schematic diagram of a core network device 1400 according to some embodiments of the present disclosure;

FIG. 15 is a schematic diagram of an access network device 1500 according to some embodiments of the present disclosure;

FIG. 16 is a schematic diagram of a core network device 1600 according to some embodiments of the present disclosure;

FIG. 17 is a schematic structural diagram of a communication device 1700 according to some embodiments of the present disclosure; and

FIG. 18 is a schematic structural diagram of an apparatus according to some embodiments of the present disclosure.

### DETAILED DESCRIPTION

The technical solutions according to the embodiments of the present disclosure are described hereinafter in conjunction with the accompanying drawings in the embodiments of the present disclosure. The described embodiments are merely part but not all of the embodiments of the present disclosure. All other embodiments derived by those skilled in the art without creative efforts based on the embodiments in the present disclosure shall fall within the protection scope of this application.

Embodiments of the present disclosure may be applicable to various communication systems, such as a global system of mobile communication (GSM) system, a code division multiple access (CDMA) system, a wideband code division multiple access (WCDMA) system, and a general packet radio service (GPRS) system, a long-term evolution (LTE) system, an advanced long-term evolution (LTE-A) system, and a new radio (NR) system, an evolution system of an NR system, an LTE-based access to unlicensed spectrum (LTE-U) system, an NR-based access to unlicensed spectrum (NR-U) system, a universal mobile telecommunication system (UMTS), a wireless local area network (WLAN) system, a wireless fidelity (Wi-Fi) system, a next-generation communication system (NGCS), or other communication systems.

Typically, traditional communication systems support a limited number of connections and are easy to implement. However, with the development of communication technologies, mobile communication systems will support not only traditional communication, but also, for example, device-to-device (D2D) communication, machine-to-machine (M2M) communication, machine-type communication (MTC), and vehicle-to-vehicle (V2V) communication, to which embodiments of the present disclosure may also be applicable.

In some embodiments, the communication system in the embodiments of the present disclosure is applicable to a carrier aggregation (CA) scenario, a dual connectivity (DC) scenario, or a standalone (SA) networking scenario.

The spectrum to which the embodiments of the present disclosure may be applicable is not limited herein. For example, the embodiments of the present disclosure may be applicable to a licensed spectrum or an unlicensed spectrum.

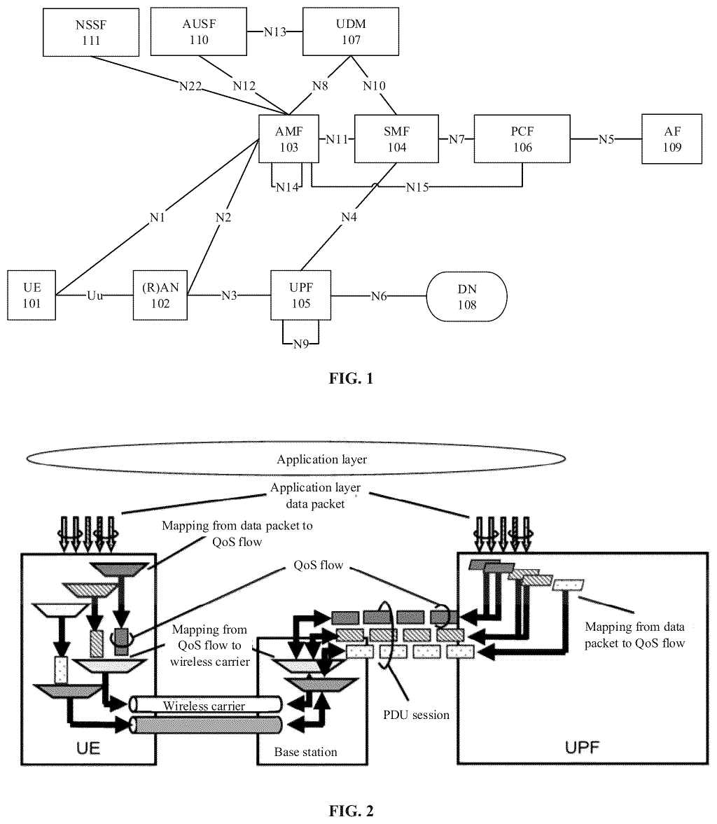

FIG. 1 exemplarily illustrates a schematic diagram of a communication system 100 to which the present disclosure is applicable. As shown in FIG. 1, the communication system 100 primarily includes user equipment (UE) 101, an access network (AN) device 102, an access and mobility management function (AMF) entity 103, a session management function (SMF) entity 104, a user-plane function (UPF) entity 105, a policy control function (PCF) entity 106, a unified data management (UDM) entity 107, a data network (DN) 108, an application function (AF) entity 109, an authentication server function (AUSF) entity 110, and a network slice selection function (NSSF) entity 111.

Specifically, in the communication system 100, the UE 101 establishes an access stratum connection with the AN device 102 over a Uu interface to implement access stratum messages interaction and wireless data transmission. The UE 101 establishes a non-access stratum (NAS) connection to the AMF entity 103 over an N1 interface to implement NAS messages interaction. The AN device 102 is connected to the AMF entity 103 over an N2 interface, and the AN device 102 is connected to the UPF entity 105 over an N3 interface. A plurality of UPF entities 105 are connected to each other over an N9 interface, and the UPF entity 105 is connected to the DN 108 over an N6 interface, meanwhile, the UPF entity 105 is connected to the SMF entity 104 over an N4 interface. The SMF entity 104 is connected to the PCF entity 106 over an N7 interface, the SMF entity 104 is connected to the UDM entity 107 over an N10 interface, the SMF entity 104 controls the UPF entity 105 over the N4 interface, meanwhile, the SMF entity 104 is connected to the AMF entity 103 over an N11 interface. A plurality of AMF entities 103 are connected to each other over an N14 interface, the AMF entity 103 is connected to the UDM entity 107 over an N8 interface, the AMF entity 103 is connected to the AUSF entity 110 over an N12 interface, the AMF entity 103 is connected to the NSSF entity 111 over an N22 interface, meanwhile, the AMF entity 103 is connected to the PCF entity 106 over an N15 interface. The PCF entity 106 is connected to the AF entity 109 over an N5 interface. The AUSF entity 110 is connected to the UDM entity 107 over an N13 interface.

In the communication system 100, the UDM entity 107 is a subscription database in a core network, storing user subscription data in the 5G network. The AMF entity 103 is a mobility management function in the core network, and the SMF entity 104 is a session management function in the core network. The AMF entity 103, in addition to performing the mobility management on the UE 101, is responsible for forwarding messages related to session management between the UE 101 and the SMF entity 104. The PCF entity 106 is the policy management function in the core network, and is responsible for formulating policies related to the mobility management, session management, charging and the like for the UE 101. The UPF entity 105 is the user-plane function in the core network, and transmits data with an external data network over the N6 interface and transmits data with the AN device 102 over the N3 interface. The UE 101, upon accessing the 5G network over the Uu interface, establishes a protocol data unit (PDU) session data connection from the UE 101 to the UPF entity 105 under the control of the SMF entity 104 to transmit data. The AMF entity 103 and the SMF entity 104 acquire user subscription data from the UDM entity 107 over the N8 and N10 interfaces and acquire policy data from the PCF entity 106 over the N15 and N7 interfaces.

Additionally, a network exposure function (NEF) entity is present in the communication system 100 and is configured to transmit information with a third-party application server interface between a core network node and a third-party application.

It should be noted that the above-described communication system 100 is illustrated using an example of a 5^{th} generation (5G) communication system, the present disclosure may also apply to other 3^{rd} generation partnership project (3GPP) communication systems, such as a 4^{th} generation (4G) communication system or a future 3GPP communication system, which are not limited herein.

It should be understood that a device having a communication function in a network/system in the embodiments of the present disclosure may be referred to as a communication device.

It is understood that the terms “system” and “network” are often used interchangeably herein. The term “and/or”, as used herein, merely describes an association relationship between associated objects, and indicates that three types of relationships. For example, the phrase “A and/or B” means (A), (B), or (A and B). In addition, the symbol “/” used herein generally indicates an “or” relationship between the associated objects.

Embodiments of the present disclosure are described in conjunction with terminal devices, access network devices, and core network devices. The terminal device is referred to as a user device, an access terminal, a subscriber unit, a subscriber station, a mobile station, a remote station, a remote terminal, a mobile device, a subscriber terminal, a terminal, a wireless communication device, a subscriber agent, a subscriber apparatus, or the like. The terminal device is a station (ST) in a WLAN, a cellular phone, a cordless phone, a Session Initiation Protocol (SIP) phone, a wireless local loop (WLL) ST, a personal digital assistant (PDA) device, a handheld device with the wireless communication function, a computing device or other processing devices connected to a wireless modem, an in-vehicle device, a wearable device, a next-generation communication system, such as a terminal device in an NR network, a terminal device in a future evolved public land mobile network (PLMN) network, or the like.

By way of example but not limitation, in the embodiments of the present disclosure, the terminal device is also a wearable device. The wearable device is also referred to as a wearable smart device, and is a general name of wearable devices such as eyeglasses, gloves, watches, clothing, and shoes, which are intelligently designed and developed for daily wear by using wearable technologies. The wearable device is a portable device that is worn directly on the body or integrated into the user's clothing or accessories. The wearable device is not only a hardware device but also implements powerful functions by software support, data interaction, and cloud interaction. The wearable smart device in a broad sense includes devices such as smart watches or smart glasses that have full functionality and large size, and are capable of implementing all or part of functionality without depending on the smart phone, and devices such as various types of smart bracelets and smart jewelries for monitoring physical signs, which are dedicated to a specific type of application functions and need to be used in cooperation with other devices such as the smart phone.

The above access network device is a device for communicating with a mobile device, and the access network device is an access point (AP) in a WLAN, a base transceiver station (BTS) in a GSM or CDMA, a NodeB (NB) in a WCDMA, an evolutional Node B (NB or eNodeB) in an LTE, a relay station, an AP, an in-vehicle device, a wearable device, or a gNB in an NR network, or a network device in a future evolved PLMN network.

In some embodiments of the present disclosure, the access network device provides services for a cell, and the terminal device communicates with the access network device over transmission resources (e.g., frequency domain resources or spectrum resources) used by the cell. The cell is a cell corresponding to the access network device (e.g., a base station). The cell belongs to a macro base station or a base station corresponding to a small cell. The small cell includes a metro cell, a micro cell, a pico cell, and a femto cell, or the like. The small cells have a small coverage area and a low transmit power, and are suitable for providing a high-speed data transmission service.

FIG. 2 is a schematic diagram of a Quality of Service (QOS) model for 5G networks. As shown in FIG. 2, QoS control in 5G networks is based on QoS flow granularity. The UE, upon accessing the 5G network over the Uu interface, establishes QoS flows under the control of SMF for data transmission, and the SMF provides the base station with QoS flow configuration information for each QoS flow, which includes a 5G QoS Identifier (5QI), an Address Resolution Protocol (ARP), and information such as the bit rate requirement. The 5QI is an index value that corresponds to the QoS characteristics, such as the delay, bit error rate requirement, and the like, and the ARP allocates or retains priority of resources for QoS flows. For each QoS flow, the base station schedules radio resources to guarantee the QoS requirements of the QoS flow based on the QoS flow configuration information received from the SMF.

Currently, upon acquiring a current video frame, an access network device does not learn the transmission situation of a reference frame of the current video frame, but directly transmits the current video frame to a terminal device. Upon receiving the current video frame, the terminal device determines whether the reference frame of the current video frame is successfully transmitted or decoded. In the case that the transmission or the decoding of the reference frame fails, the terminal device discards the current video frame, which leads to a waste of air interface resources. In addition, in the case of network congestion, there are often multiple video frames to be transmitted, and thus how to reasonably schedule the air interface resources is a technical problem to be solved in the present disclosure.

FIG. 3 exemplarily illustrates a schematic diagram of a user-plane protocol stack. As shown in FIG. 3, the UPF parses at most a PDU layer of a data packet. For example, the UPF parses an Internet Protocol (IP) layer of the data packet, but cannot parse an application layer. In addition, the access network device also parses at most a user-plane part of the Tunneling Protocol (GTP) (GTP-U) layer, and cannot parse the application layer cither. Usually, application layer packet header information of the data packet may carry information of a data set with which the data packet has a dependency relationship. For example, one current video frame includes at least one data packet, and the application layer packet header information of these data packets carries information of a reference frame of the current video frame, such as an identifier of the reference frame. However, since the UPF and the access network device cannot parse the application layer, the access network device cannot know the information of the reference frame of the current video frame, and thus cannot know the transmission situation of the reference frame, but directly transmits the current video frame to the terminal device. Upon receiving the current video frame, the terminal device determines whether the transmission of the reference frame of the current video frame is successful or whether the reference frame is successfully decoded. In the case that the transmission or decoding of the reference frame fails, the terminal device discards the current video frame, which leads to the waste of air interface resources. In addition, in the case of network congestion, there are often multiple video frames to be transmitted, and how to reasonably schedule the air interface resources is a technical problem to be addressed in the present disclosure.

To address the above technical problem, in the present disclosure, an access network device is capable of acquiring information for determining importance and/or an association relationship of a plurality of data sets, such that the device is capable of scheduling the air interface resources based on the importance and/or the association relationship of the plurality of data sets.

It should be understood that not only the video frames have a dependency relationship, other data, such as coded slices (or video slices), data from multimodal services, and data from remote control services, also has a dependency relationship, and even data in other forms has a dependency relationship between them. Based on this, in the present disclosure, the video frames, the coded slices, the data from the multimodal service, or the data from the remote control service are referred to as data sets, which are also referred to as data units. Each data set includes one or more data packets, wherein the data packets in any one of the data sets have the same importance at the application layer.

### Embodiment 1

The technical solutions of the present disclosure are described in detail hereinafter.

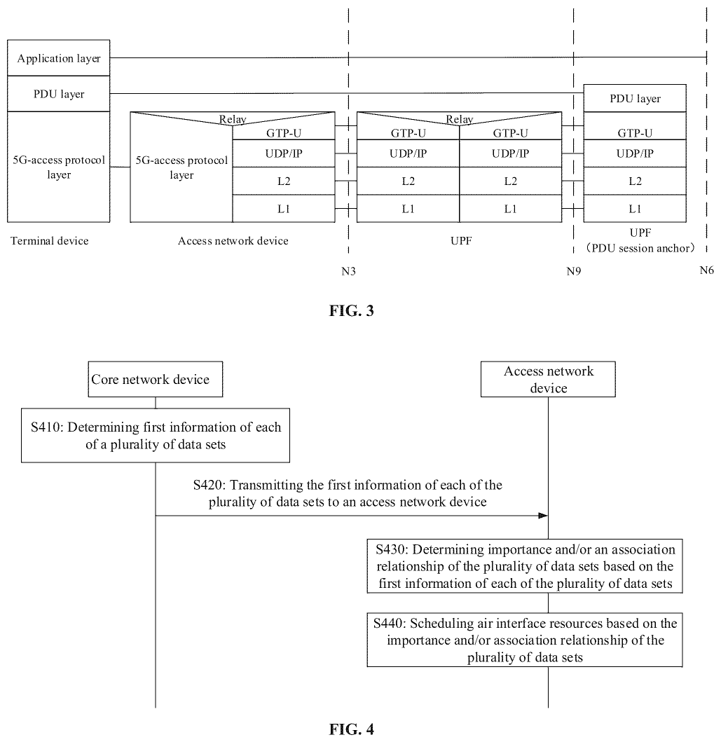

FIG. 4 is an interaction flowchart of a method for wireless communication according to some embodiments of the present disclosure. As shown in FIG. 4, the method includes the following processes.

In S410, a core network device determines first information of each of a plurality of data sets.

In S420, the core network device transmits the first information of each of the plurality of data sets to an access network device.

In S430, the access network device determines importance and/or an association relationship of the plurality of data sets based on the first information of each of the plurality of data sets.

In S440, the access network device schedules air interface resources based on the importance and/or association relationship of the plurality of data sets.

In some embodiments, the core network device in the embodiments is a user-plane core network device, such as a UPF, or a control-plane core network device, such as an AF.

In some embodiments, the plurality of data sets described above are a plurality of video frames, a plurality of coded slices, a plurality of data sets from a multimodal service, or a plurality of data sets from a remote control service, which are not limited herein.

In some embodiments, the core network device transmits the first information of each of the plurality of data sets to the access network device independently.

It should be understood that the first information of each of the plurality of data sets is configured to determine the importance and/or association relationship of the plurality of data sets.

In some embodiments, the first information of each data set includes any one of: a type of the data set, an importance level of the data set, a period of a data set sequence to which the data set belongs, or a data size of the data set.

In some embodiments, in the case that the data set is a data set of a multimodal service or a remote control service, the type of the data set is a service type, such as a voice type or a video type. In the case that the data set is a video frame, then the type of the data set is a frame type, such as an I-frame type, a P-frame type, or a B-frame type. In the case that the data set is a coded slice, then the type of the data set is a coded slice type, such as an I-slice, a P-slice, or a B-slice.

In some embodiments, the importance level of the data set is defined as most important, more important, or less important, or the importance level of the data set is defined as non-discardable and discardable, which is not limited herein.

In some embodiments, the importance level of the data set is indicated by a corresponding index. For example, 1 indicates most important, 2 indicates more important, and 3 indicates less important. Alternatively, 1 indicates non-discardable, and 2 indicates discardable.

In some embodiments, the data set sequence includes a first data set sequence and/or a second data set sequence. The first data set sequence includes a plurality of types of data sets. The second data set sequence includes a single type of data set.

Exemplarily, in the case that the data set is a video frame. For a video frame sequence such as an I-frame, a P-frame, a P-frame, a B-frame . . . , the video frame sequence includes a plurality of types of video frames, and is therefore in the case of the first data set sequence.

Exemplarily, in the case that the data set is a video frame. For a video frame sequence that is all I-frames, it is in the case of the second data set sequence.

It should be understood that the period of the first data set sequence described above refers to a time interval between any two adjacent data sets in the first data set sequence. In the case that the first data set sequence is composed of a plurality of video frames, then the period of the first data set sequence is related to a frame rate. In the case that the second data set sequence is the I-frame, then the period of the second data set sequence refers to a group of pictures (GOP) period. In the case that the second data set sequence is the P-frame, then the period of the second data set sequence refers to a reference period.

It should be understood that the access network device identifies each independent data set based on the period of the first data set sequence, and identifies data sets of the same type based on the period of the second data set sequence. Using video frames as an example, the access network device locally defines a timer with a duration of the GOP period, the reference period, and the frame interval, such that each independent video frame, the I-frame, and the P-frame are located.

It should be understood that at least one of the plurality of data sets described above carries a period of a data set sequence to which the at least one of the plurality of data sets belongs.

It should be understood that the data size of the data set refers to the number of bits included in that data set.

In some embodiments, the access network device determines the importance and/or association relationship of the plurality of data sets based on the priori information and the first information of each of the plurality of data sets.

It should be understood that the association relationship of the plurality of data sets is also referred to as a dependency relationship or attachment relationship of the plurality of data sets, which is not limited herein.

In some embodiments, the priori information is predefined, configured by the access network device, or configured by any other core network device.

In some embodiments, the priori information includes a correspondence relationship between the first information of each of the plurality of data sets and the importance of the plurality of data sets, and/or, a correspondence relationship between the first information of each of the plurality of data sets and the association relationship between the plurality of data sets.

The process of the access network device determining the importance of the plurality of data sets based on the first information of each of the plurality of data sets is described hereinafter by several examples.

In example 1, in the case that the data set is a video frame and the first information of the video frame includes a type of the video frame, and in the case that a first video frame is an I-frame, a second video frame is a P-frame, a third video frame is a B-frame, and a fourth video frame is a P-frame, . . . , then the access network device determines, based on priori information, that importance of the first video frame is higher than importance of the second video frame, the importance of the second video frame is higher than importance of the fourth video frame, and the importance of the fourth video frame is higher than importance of the third video frame.

In example 2, in the case that the data set is a video frame and the first information of the video frame includes an importance level of the video frame, and in the case that an importance level of a first video frame is 1, an importance level of a second video frame is 2, an importance level of a third video frame is 3, an importance level of a fourth video frame is 2, . . . , and in the case that the smaller the index corresponding to the importance level of the video frame, the higher the importance of that video frame, then the access network device determines that the first video frame is the most important, the second video frame and the fourth video frame are the second most important, and the third video frame is the least important.

In example 3, in the case that the data set is a video frame and the first information of the video frames includes a GOP period, then the access network device determines each independent I-frame based on the GOP period. For example, the access network device determines that the I-frame occurs every 66 ms based on the GOP period. Based on this, the access network device determines the arrival time of all I-frames, determines these video frames as the most important video frames, and determines video frames that arrive at other times as the second or least important video frames.

In example 4, in the case that the data set is a video frame and the first information of the video frames includes a reference period, then the access network device determines each independent P-frame based on the reference period. For example, the access network device determines that the P-frame occurs every 66 ms based on the reference period. Based on this, the access network device determines the arrival time of all P-frames, determines these video frames as the least important video frames, and determines video frames arriving at the rest of the time as the important video frames.

In example 5, in the case that the data set is a video frame and the first information of the video frames includes a GOP period and a reference period, then the access network device determines each independent I-frame based on the GOP period. For example, the access network device determines that the I-frame occurs every 66 ms from the start of receiving the video frames based on the GOP period, and determines that the P-frame occurs every 33 ms from the start of receiving the video frames based on the reference period. Based on this, the access network device determines the arrival time of all I-frames, determines these video frames as the most important video frames, and determines the arrival time of all P-frames and determines these video frames as the least important video frames.

In example 6, in the case that the data set is a video frame and that the first information of the video frame includes a period of a video frame sequence composed of different types of video frames (i.e., a time interval between any adjacent video frames in the sequence), then the access network device determines each independent video frame based on the time interval, determines video frames numbered with odd numbers as the most important video frames, and determines video frames numbered with even numbers as the least important video frames.

In example 7, in the case that the data set is a video frame and the first information of the video frame includes a period of a video frame sequence composed of different types of video frames (i.e., a time interval between any adjacent video frames in the sequence) and the GOP period, then the access network device determines each independent video frame based on the time interval and determines that the I-frame occurs every 66 ms from the start of receiving the video frames based on the GOP period. Based on this, the access network device determines the arrival time of all I-frames and other types of frames, determines these I-frames as the most important video frames, and determines video frames arriving at the rest of time as the second most important or least important video frames.

In example 8, in the case that the data set is a video frame and the first information of the video frame includes a period of a video frame sequence composed of different types of video frames (i.e., a time interval between any adjacent video frames in the sequence) and a reference period, then the access network device determines each independent video frame based on the time interval and determines that the P-frame occurs every 33 ms from the start of receiving the video frames based on the reference period. Based on this, the access network device determines the arrival time of all P-frames and other types of frames, determine these P-frames as the least important video frames, and determines video frames arriving at the rest of the time as the most important video frames.

In example 9, in the case that the data set is a video frame and the first information of the video frame includes a period of video frame sequence composed of video frames of different importance levels (i.e., a time interval between any adjacent video frames in the sequence), a GOP period, and a reference period, the access network device determines each independent video frame based on the time interval, and determines that the I-frame occurs every 66 ms from the start of receiving the video frame based on the GOP period, and determines that the P-frame occurs every 33 ms from the start of receiving the video frames based on the reference period. Based on this, the access network device determines the arrival time of all I-frames, P-frames, and other types of frames, determines these I-frames as the most important video frames and these P-frames as the second most important video frames, and determines the remaining video frames as the least important video frames.

In example 10, in the case that the data set is a video frame and the first information of the video frame includes a size of the video frame, and in the case that a size of a first video frame is greater than or equal to a first predefined threshold, a size of a second video frame is greater than a second predefined threshold and is less than or equal to the first predefined threshold, a size of a third video frame is less than the first predefined threshold, and a size of a fourth video frame is greater than the second predefined threshold and is less than or equal to the first preset threshold, . . . , then the access network device determines, based on priori information, that the first video frame is an I-frame, the second video frame is a P-frame, the third video frame is a B-frame, and the fourth video frame is a P-frame. Based on this, the access network device determines, based on the priori information, that the first video frame is more important than the second video frame, the second video frame is more important than the fourth video frame, and the fourth video frame is more important than the third video frame.

In example 11, in the case that the data set is a 3D video frame, the first information of the video frame includes a type of the video frame, and the type of any video frame is a left eye view type or a right eye view type, then the access network device determines that a video frame of the left eye view type is more important than a video frame of the right eye view type based on priori information.

In example 12, in the case that the data set is a coded slice and the first information of the coded slice includes a type of the coded slice, and in the case that a first coded slice is a type I coded slice, a second coded slice is a type P coded slice, a third coded slice is a type B coded slice, and a fourth coded slice is a type P coded slice, . . . , then the access network device determines, based on priori information, that the first coded slice is more important than the second coded slice, the second coded slice is more important than the fourth coded slice, and the fourth coded slice is more important than the third coded slice.

The process of the access network device determining the association relationship of the plurality of data sets based on first information of each of the plurality of data sets is described hereinafter by several examples.

In example 13, in the case that the data set is a video frame and the first information of the video frame includes a type of the video frame, and in the case that a first video frame is an I-frame, a second video frame is a P-frame, a third video frame is a B-frame, and a fourth video frame is a P-frame, . . . , then the access network device determines, based on priori information, that a reference frame of the second video frame is the first video frame, reference frames of the third video frame are the second video frame and the fourth video frame, and a reference frame of the fourth video frame is the second video frame.

In example 14, in the case that the data set is a video frame and the first information of the video frame includes an importance level of the video frame, and in the case that an importance level of a first video frame is 1, an importance level of a second video frame is 2, an importance level of a third video frame is 3, an importance level of a fourth video frame is 2, . . . , then the access network device determines, based on priori information, that a reference frame of the second video frame is the first video frame, reference frames of the third video frame are the second video frame and the fourth video frame, and a reference frame of the fourth video frame is the second video frame.

In example 15, in the case that the data set is a video frame and the first information of the video frame includes a GOP period, then the access network device determines each independent I-frame based on the GOP period. For example, the access network device determines that the I-frame occurs every 66 ms based on the GOP period. Based on this, the access network device determines the arrival time of all I-frames and further determines the arrival time of other video frames. Furthermore, the access network device determines, based on priori information, that a reference frame of any video frame between two I-frames is the former of the two I-frames.

In example 16, in the case that the data set is a video frame and the first information of the video frame includes a reference period, then the access network device determines each independent P-frame based on the reference period. For example, the access network device determines that the P-frame occurs every 66 ms based on the reference period. Based on this, the access network device determines the arrival time of all P-frames. Further, the access network device determines, based on priori information, that a reference frame of each P-frame is a previous I-frame or P-frame of the P-frame.

In example 17, in the case that the data set is a video frame and the first information of the video frame includes a GOP period and a reference period, then the access network device determines each independent I-frame based on the GOP period. For example, the access network device determines that the I-frame occurs every 66 ms from the start of receiving the video frames based on the GOP period, and determines that the P-frame occurs every 33 ms from the start of receiving the video frames based on the reference period. Based on this, the access network device determines, based on priori information, that a reference frame of each P-frame is a previous I-frame of the P-frame.

In example 18, in the case that the data set is a video frame and the first information of the video frame includes a period of a video frame sequence composed of different types of video frames (i.e., a time interval between any adjacent video frames in the sequence), then the access network device determines each independent video frame based on the time interval and determines that a reference frame of each even-numbered video frame is a previous frame of the each even-numbered video frame based on priori information.

In example 19, in the case that the data set is a video frame and the first information of the video frame includes a period of a video frame sequence composed of different types of video frames (i.e., a time interval between any adjacent video frames in the sequence) and a GOP period, then the access network device determines each independent video frame based on the time interval and determines that the I-frame occurs every 66 ms from the start of receiving the video frames based on the GOP period. Further, the access network device determines, based on priori information, that a reference frame of any video frame between two I-frames is the former of the two I-frames.

In example 20, in the case that the data set is a video frame and the first information of the video frame includes a period of a video frame sequence composed of different types of video frames (i.e., a time interval between any adjacent video frames in the sequence) and a reference period, then the access network device determines each independent video frame based on the time interval and determines that the P-frame occurs every 33 ms from the start of receiving the video frames based on the reference period. Based on this, the access network device determines the arrival time of all P-frames and other types of frames, and further, the access network device determines that a reference frame of each P-frame is a previous P-frame of the each P-frame based on priori information.

In example 21, in the case that the data set is a video frame and the first information of the video frame includes a period of a video frame sequence composed of different types of video frames (i.e., a time interval between any adjacent video frames in the sequence), a GOP period, and a reference period, the access network device determines each independent video frame based on the time interval, determines that the I-frame occurs every 66 ms from the start of receiving the video frames based on the GOP period, and determines that the P-frame occurs every 33 ms from the start of receiving the video frames based on the reference period. Based on this, the access network device determines the arrival time of all I-frames, P-frames, and other types of frames, and further, the access network device determines, based on priori information, that a reference frame of each P-frame is a previous I-frame or a previous P-frame of the each P-frame.

In example 22, in the case that the data set is a video frame and the first information of the video frame includes a size of the video frame, and in the case that a size of a first video frame is greater than or equal to a first predefined threshold, a size of a second video frame is greater than a second predefined threshold and is less than or equal to the first predefined threshold, a size of a third video frame is less than the second predefined threshold, a size of a fourth video frame is greater than the second predefined threshold and is less than or equal to the first preset threshold, . . . , then the access network device determines, based on priori information, that the first video frame is an I-frame, the second video frame is a P-frame, the third video frame is a B-frame, and the fourth video frame is a P-frame. Further, the access network device determines, based on the priori information, that a reference frame of each P-frame is a previous I-frame or a previous P-frame of the each P-frame, and reference frames of each B-frame are a previous frame and a next frame of the each B frame.

In example 23, in the case that the data set is a 3D video frame and the first information of the video frame includes a type of the video frame, and in the case that a first video frame is a video frame of a left eye view type, a second video frame is a video frame of a right eye view type, a third video frame is a video frame of a left eye view type, a fourth video frame is a video frame of a right eye view type, . . . , then the access network device determines, based on priori information, that a reference frame of the video frame of the right eye view type is its previous video frame of the left eye view type.

In example 24, in the case that the data set is a coded slice and the first information of the coded slice includes a type of the coded slice, and in the case that a first coded slice is a type I coded slice, a second coded slice is a type P coded frame, a third coded slice is a type B coded frame, and a fourth coded slice is a type P coded frame, . . . , then the access network device determines, based on priori information, that a reference frame of the second coded slice is the first coded slice, reference frames of the third coded slice are the second coded slice and the fourth coded slice, and a reference frame of the fourth coded slice is the second coded slice.

In some embodiments, the access network device determines a data set with importance higher than a predefined importance among the plurality of data sets, and prioritizing schedules air interface resources to the data set with importance higher than a predefined importance among the plurality of data sets; and/or, the access network device determines a reference data set of a target data set based on the association relationship of the plurality of data sets and determines a transmission situation of the reference data set, and in the case that it is determined based on the transmission situation of the reference data set that the reference data set cannot be transmitted correctly, the access network device discards the reference data set and/or the target data set.

Exemplarily, in the case that the network is currently in a congested state and video frames to be transmitted are an I-frame, a P-frame, a B-frame, a P-frame, and the like. The I-frame has the highest importance, the first P-frame has the second highest importance, the second P-frame has a lower importance than the first P-frame, and the B-frame has the lowest importance, and therefore, the access network device prioritizes transmitting the I-frame. In the case that there is no available air interface resource upon allocating the air interface resource to the I frame, the access network device discards the P frames and B frames. In the case that there are still available air interface resources upon allocating the air interface resource to the I frame, the access network device allocates the air interface resource to the first P frame and continues to determine whether there are still available air interface resources upon allocating the air interface resource to the first P frame. In the case that there is no available air interface resource, the second P-frame and B-frame are discarded, and the like.

Exemplarily, in the case that the transmission or decoding of a reference frame of a P-frame fails, then the access network device discards the P-frame.

In summary, in the present disclosure, the core network device determines first information of each of the plurality of data sets and transmits the first information of each of the plurality of data sets to the access network device. The access network device determines the importance and/or the association relationship of the plurality of data sets based on the first information of each of the plurality of data sets, and schedules the air interface resources based on the importance and/or the association relationship of the plurality of data sets. In this way, the air interface resources are reasonably scheduled, and thus the problem of wasting air interface resources is addressed.

In some embodiments, the first information of each of the plurality of data sets is from the user-plane or the control-plane of the core network, which is described hereinafter through two embodiments.

### Embodiment 2

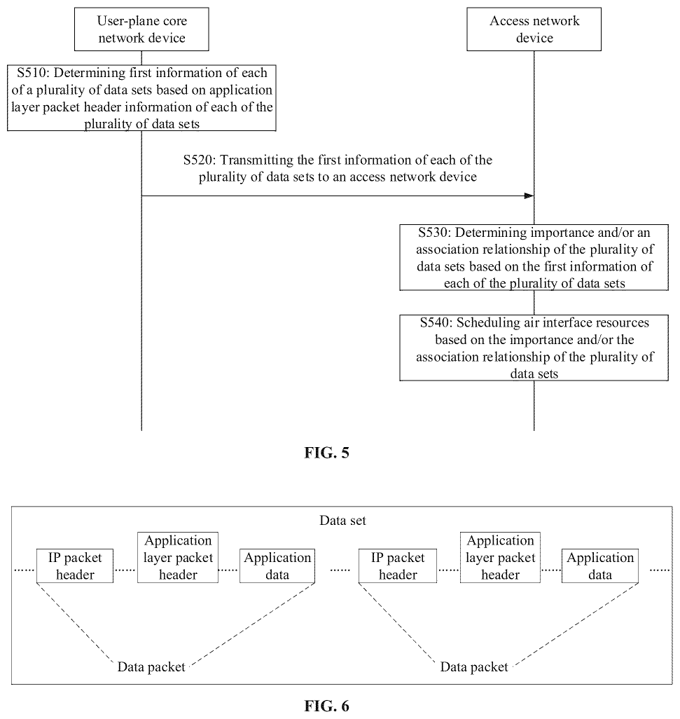

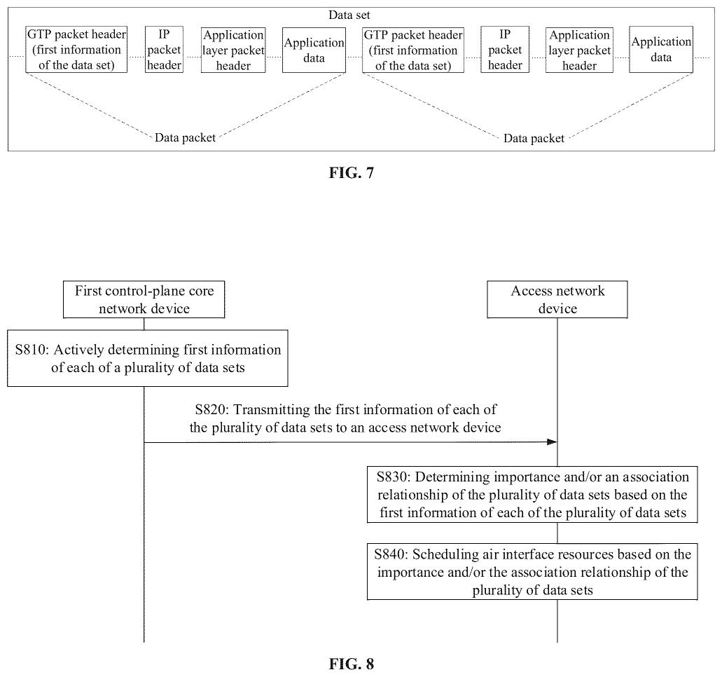

FIG. 5 shows an interaction flowchart of another method for wireless communication according to some embodiments of the present disclosure. As shown in FIG. 5, the method includes the following processes.

In S510, a user-plane core network device determines first information of each of a plurality of data sets based on application layer packet header information of each of the plurality of data sets.

In S520, the user-plane core network device transmits the first information of each of the plurality of data sets to an access network device.

In S530, the access network device determines importance and/or an association relationship of the plurality of data sets based on the first information of each of the plurality of data sets.

In S540, the access network device schedules air interface resources based on the importance and/or the association relationship of the plurality of data sets.

In some embodiments, each data set includes at least one data packet.

In some embodiments, for each data set, the user-plane core network device parses application layer packet header information of at least one data packet included in the data set, and determines the first information of the data set based on the application layer packet header information.

It should be understood that for each data set, the at least one data packet parsed by the user-plane core network device is all of the data packets or a portion of the data packets of the data set.

The application layer in the present invention refers to a protocol layer above the PDU layer, including for example, but not limited to at least one of a Real-time Transport Protocol (RTP) layer, a Hypertext Transfer Protocol (HTTP) layer, H.264 and H.265 of data compression, or a Moving Picture Experts Group (MPEG) coding layer. The corresponding application layer packet header refers to, for example, at least one of an RTP packet header, an HTTP packet header, an H.264 packet header, an H.265 packet header, an MPEG packet header, or the like. Exemplarily, the user-plane core network device reads the RTP packet header or reads a data packet header encoded and compressed by a video codec such as H.264, H.265, or MPEG.

In some embodiments, the user-plane core network device adds the first information of each data set to a packet header other than an IP packet header of the data set, such as adding the first information of the data set to a GTP packet header of the data set.

Exemplarily, FIG. 6 is a schematic diagram of a data set according to some embodiments of the present disclosure. As shown in FIG. 6, the data set includes at least one data packet. Each data packet includes application data, an application layer packet header, and an IP packet header. In a video transmission scenario, the application data is a pixel point in a video frame and an attribute of the pixel point. The application layer packet header information is configured to determine first information of the data set. The IP packet header includes an IP of an application server and an IP of a terminal device. The application server is a cloud game server in a cloud game scenario, and the terminal device is a receiving terminal of the downlink data packet. i.e., an end-to-end terminal. Combined with FIG. 3, at present, the access network device at most parses the GTP-U layer, and the access network device is unable to parse the above-described data packet. Based on this, in some embodiments, the user-plane core network device adds the first information of the data set to the packet header other than the IP packet header of the data set. For example, the user-plane core network device adds the first information of the data set to the GTP packet header of the data set or other location as long as the access network device parses this location.

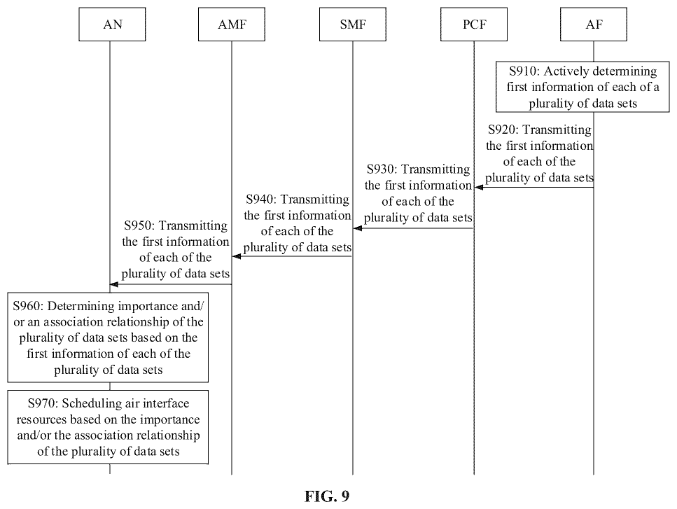

Exemplarily, FIG. 7 is a schematic diagram of another data set according to some embodiments of the present disclosure. The user-plane core network device adds the first information of the data set to the GTP packet header of the data set, as shown in FIG. 7.

It should be understood that the ellipses in FIGS. 6 and 7 indicate that some other information may be present, or there may be no information at all.

It should be understood that for each data set, the data packet parsed by the user-plane core network device is identical to or different from the data packet of the first information to be added.

In some embodiments, the application layer packet header information of each data set includes the first information of that data set.

Exemplarily, in the case that a data set is a video frame that includes 10 data packets, application layer packet header information of each data packet includes first information of the video frame.

In some embodiments, the application layer packet header information does not directly include the first information of the data set, but rather the first information of the data set is determined based on the application layer packet header information.

Exemplarily, in the case that a data set is a video frame that includes 10 data packets, application layer packet header information of each data packet includes indication information at a predetermined location. Based on this, the user-plane core network device determines first information indicated by the indication information.

In some embodiments, the user-plane core network device maps each data set to a corresponding QoS flow based on a QoS requirement and transmits the data set down to the access network device.

In the present disclosure, the user-plane core network device determines the first information of each of the plurality of data sets based on the application layer packet header information of each of the plurality of data sets and transmits the first information of each of the plurality of data sets to the access network device. The access network device determines the importance and/or the association relationship of the plurality of data sets based on the first information of each of the plurality of data sets and schedules the air interface resources based on the importance and/or the association relationship of the plurality of data sets. In this way, the air interface resources are reasonably scheduled, and thus the problem of the waste of the air interface resources is addressed.

### Embodiment 3

FIG. 8 is an interaction flowchart of another method for wireless communication according to some embodiments of the present disclosure. As shown in FIG. 8, the method includes the following processes.

In S810, a first control-plane core network device actively determines first information of each of a plurality of data sets.

In S820, the first control-plane core network device transmits the first information of each of the plurality of data sets to an access network device.

In S830, the access network device determines importance and/or an association relationship of the plurality of data sets based on the first information of each of the plurality of data sets.

In S840, the access network device schedules air interface resources based on the importance and/or the association relationship of the plurality of data sets.

In some embodiments, the first control-plane core network device is an AF.

In some embodiments, the first control-plane core network device is a trusted or untrusted control-plane core network device.

Exemplarily, as shown in FIG. 9, in the case that the first control-plane core network device is a trusted AF, the method for wireless communication includes the following processes.

In S910, an AF actively determines first information of each of a plurality of data sets.

In S920, the AF transmits the first information of each of the plurality of data sets to a PCF.

In S930, the PCF transmits the first information of each of the plurality of data sets to an SMF.

In S940, the SMF transmits the first information of each of the plurality of data sets to an AMF.

S950, the AMF transmits the first information of each of the plurality of data sets to an AN.

In S960, the AN determines importance and/or an association relationship of the plurality of data sets based on the first information of each of the plurality of data sets.

In S970, the AN schedules air interface resources based on the importance and/or the association relationship of the plurality of data sets.

In some embodiments, the first information of each of the plurality of data sets is passed-through in the form of a container between the AF, the PCF, the SMF, the AMF, and the AN.

In some embodiments, in the case that the first control-plane core network device is an untrusted control-plane core network device, the first information of each of the plurality of data sets is forwarded to the access network device upon being authenticated and authorized by the third control-plane core network device.

In some embodiments, the third control-plane core network device is a NEF.

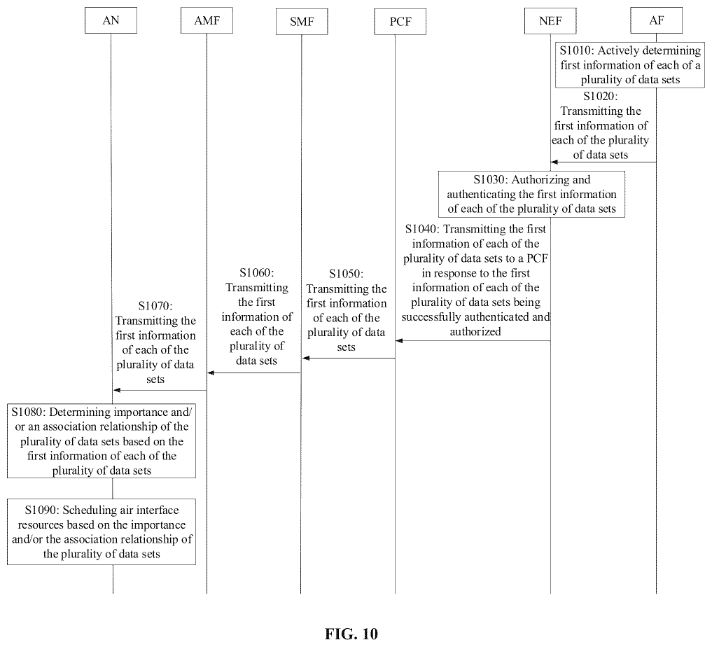

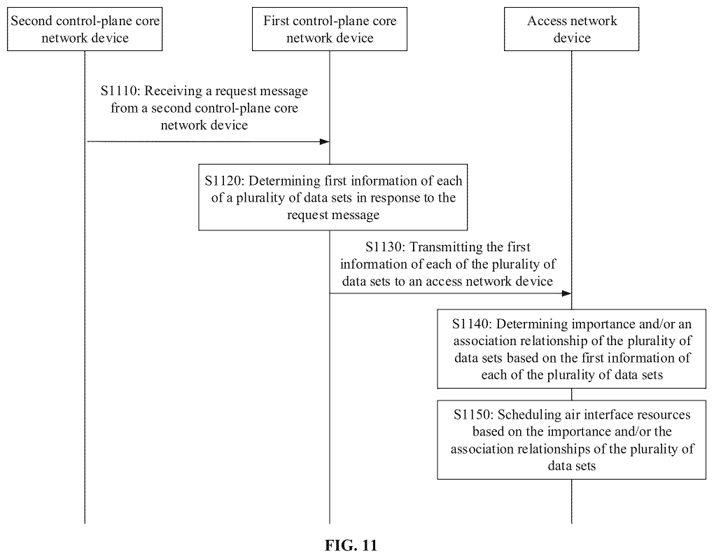

Exemplarily, as shown in FIG. 10, in the case that the first control-plane core network device is an untrusted AF, the method for wireless communication includes the following processes.

In S1010, an AF actively determines first information of each of a plurality of data sets.

In S1020, the AF transmits the first information of each of the plurality of data sets to an NEF.

In S1030, the NEF authorizes and authenticates the first information of each of the plurality of data sets.

In S1040, the NEF transmits the first information of each of the plurality of data sets to a PCF in response to the first information of each of the plurality of data sets being successfully authenticated and authorized.

In S1050, the PCF transmits the first information of each of the plurality of data sets to an SMF.

In S1060, the SMF transmits the first information of each of the plurality of data sets to an AMF.

In S1070, the AMF transmits the first information of each of the plurality of data sets to an AN.

In S1080, the AN determines importance and/or an association relationship of the plurality of data sets based on the first information of each of the plurality of data sets.

In S1090, the AN schedules air interface resources based on the importance and/or the association relationship of the plurality of data sets.

In some embodiments, the first information of each of the plurality of data sets is passed-through in the form of a container between the AF, the NEF, the PCF, the SMF, the AMF, and the AN.

In the present disclosure, the first control-plane core network device actively determines the first information of each of the plurality of data sets and transmits the first information of each of the plurality of data sets to the access network device. The access network device determines the importance and/or the association relationship of the plurality of data sets based on the first information of each of the plurality of data sets and schedules air interface resources based on the importance and/or the association relationship of the plurality of data sets. In this way, the air interface resources are reasonably scheduled, and the problem of wasted air interface resources is addressed.

### Embodiment 4

FIG. 11 is an interaction flowchart of yet another method for wireless communication according to some embodiments of the present disclosure. As shown in FIG. 11, the method includes the following processes.

In S1110, a first control-plane core network device receives a request message from a second control-plane core network device.

In S1120, the first control-plane core network device determines first information of each of a plurality of data sets in response to the request message.

In S1130, the first control-plane core network device transmits the first information of each of the plurality of data sets to an access network device.

In S1140, the access network device determines importance and/or an association relationship of the plurality of data sets based on the first information of each of the plurality of data sets.

In S1150, the access network device schedules air interface resources based on the importance and/or the association relationships of the plurality of data sets.

In some embodiments, the request message is transmitted when the second control-plane core network device determines that the network is in a congested state.

In some embodiments, the second control-plane core network device is an SMF.

In some embodiments, the request message includes a type of the first information.

Exemplarily, the SMF requests the AF to determine types and importance levels of the plurality of data sets, periods of data set sequences to which the data sets belong, or data sizes based on the request message. In the case that the SMF requests the types of the plurality of data sets, what the AF determines are the types of the plurality of data sets. In the case that the SMF requests the importance levels of the plurality of data sets, what the AF determines are the importance levels of the plurality of data sets. In the case that the SMF requests the period of the data set sequence to which the data set belongs, what the AF determines is the period of the data set sequence to which each of the plurality of data sets belongs. In the case that the SMF requests the data size, what the AF determines is the data size of each of the plurality of data sets.

In some embodiments, the request message further includes an identifier of the first control-plane core network device, such as an identifier of the AF.

In some embodiments, the first control-plane core network device is a trusted or untrusted control-plane core network device.

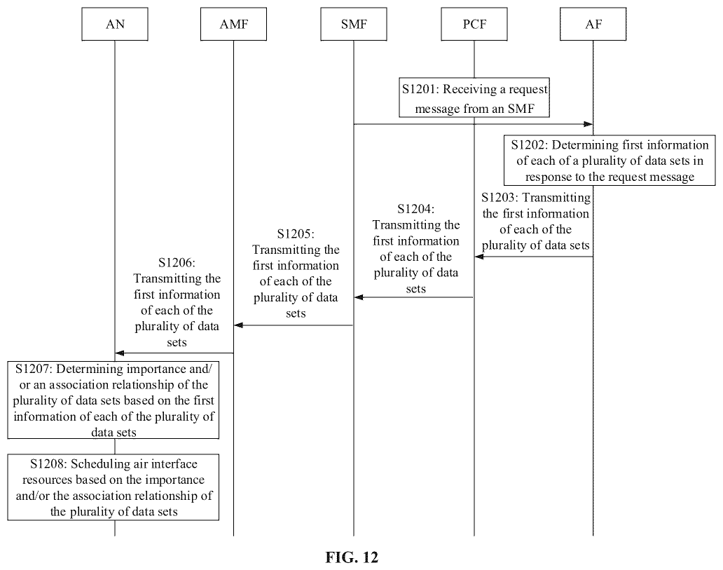

Exemplarily, as shown in FIG. 12, in the case that the first control-plane core network device is a trusted AF, the method for wireless communication includes the following processes.

In S1201, an AF receives a request message from an SMF.

In S1202, the AF determines first information of each of a plurality of data sets in response to the request message.

In S1203, the AF transmits the first information of each of the plurality of data sets to a PCF.

In S1204, the PCF transmits the first information of each of the plurality of data sets to the SMF.

In S1205, the SMF transmits the first information of each of the plurality of data sets to an AMF;

In S1206, the AMF transmits the first information of each of the plurality of data sets to an AN.

In S1207, the AN determines importance and/or an association relationship of the plurality of data sets based on the first information of each of the plurality of data sets.

In S1208, the AN schedules air interface resources based on the importance and/or the association relationship of the plurality of data sets.

In some embodiments, the first information of each of the plurality of data sets is pass-through in the form of a container between the AF, the PCF, the SMF, the AMF, and the AN.

In some embodiments, in the case that the first control-plane core network device is an untrusted control-plane core network device, the first information of each of the plurality of data sets is forwarded to the access network device upon being authenticated and authorized by the third control-plane core network device, and the request message is also forwarded to the first control-plane core network device upon being authenticated and authorized by the third control-plane core network device.

In some embodiments, the third control-plane core network device is a NEF.

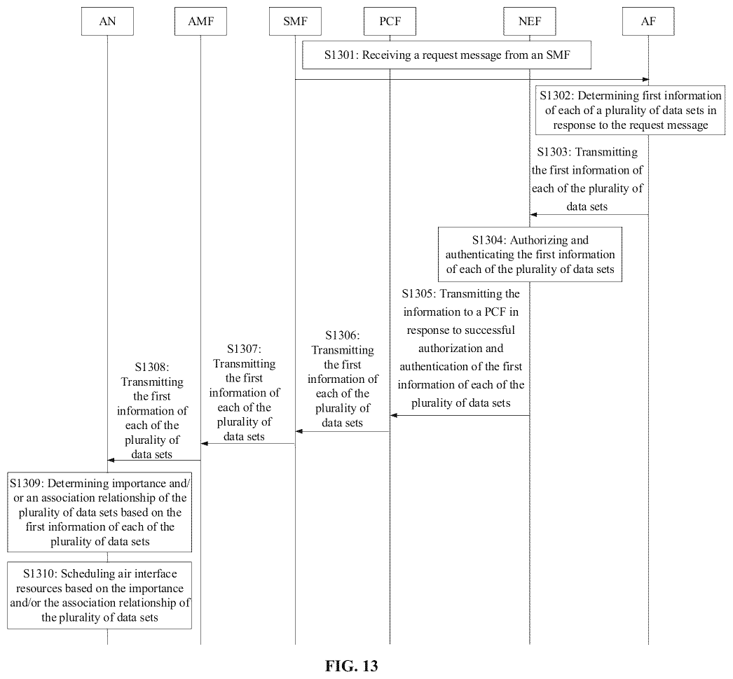

Exemplarily, as shown in FIG. 13, in the case that the first control-plane core network device is an untrusted AF, the method for wireless communication includes the following processes.

In S1301, an AF receives a request message from an SMF.

In S1302, the AF determines first information of each of a plurality of data sets in response to the request message.

In S1303, the AF transmits the first information of each of the plurality of data sets to an NEF.

In S1304, the NEF authorizes and authenticates the first information of each of the plurality of data sets.

In S1305, the NEF transmits, in response to successful authorization and authentication of the first information of each of the plurality of data sets, the first information of each of the plurality of data sets to a PCF.

In S1306, the PCF transmits the first information of each of the plurality of data sets to the SMF.

In S1307, the SMF transmits the first information of each of the plurality of data sets to an AMF.

In S1308, the AMF transmits the first information of each of the plurality of data sets to an AN.

In S1309, the AN determines importance and/or an association relationship of the plurality of data sets based on the first information of each of the plurality of data sets.

In S1310, the AN schedules air interface resources based on the importance and/or the association relationship of the plurality of data sets.

In some embodiments, the first information of each of the plurality of data sets is passed-through in the form of a container between the AF, the NEF, the PCF, the SMF, the AMF, and the AN.

In the present disclosure, the first control-plane core network device determines the first information of each of the plurality of data sets in response to the request message and transmits the first information of each of the plurality of data sets to the access network device. The access network device determines the importance and/or the association relationship of the plurality of data sets based on the first information of each of the plurality of data sets, and schedules air interface resources based on the importance and/or the association relationship of the plurality of data sets. In this way, the air interface resources are reasonably scheduled, and thus the problem of the waste of air interface resources is addressed.

In some embodiments, embodiments 2 to 4 are applicable to a data encryption scenario, such as a scenario where the data set is encrypted and the core network device is not capable of reading the application layer packet header information; or applicable to a scenario where the core network device is capable of reading the application layer packet header information but not capable of acquiring the first information directly from the application layer packet header information.

In some embodiments, the technical solution according to the present disclosure supports QOS processing of the granularity of the data set.

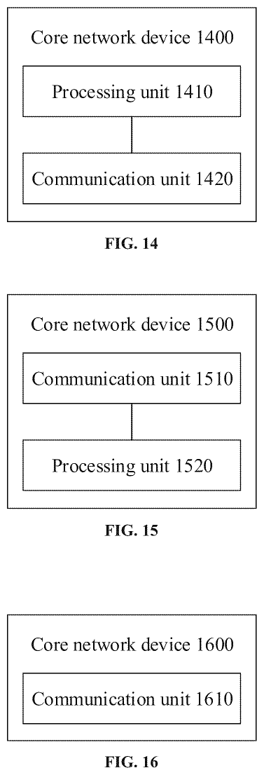

FIG. 14 is a schematic diagram of a core network device 1400 according to some embodiments of the present disclosure. As shown in FIG. 14, the core network device 1400 includes a processing unit 1410 and a communication unit 1420. The processing unit 1410 is configured to determine first information of each of a plurality of data sets. The communication unit 1420 is configured to transmit the first information of each of the plurality of data sets to an access network device. The first information of each of the plurality of data sets is configured to determine importance and/or an association relationship of the plurality of data sets, such that the access network device is capable of scheduling air interface resources based on the importance and/or the association relationship of the plurality of data sets.

In some embodiments, the core network device is a user-plane core network device, and accordingly, the processing unit 1410 is specifically configured to determine the first information of each of the plurality of data sets based on application layer packet header information of each of the plurality of data sets.

In some embodiments, the application layer packet header information of each data set includes the first information of that data set.

In some embodiments, the processing unit 1410 is further configured to add the first information of each data set to a packet header other than an IP packet header of the data set prior to the communication unit 1420 transmits the first information of each of the plurality of data sets to the access network device.

In some embodiments, the processing unit 1410 is specifically configured to add the first information of the data set to a GTP packet header of the data set.

In some embodiments, the user-plane core network device is a UPF.

In some embodiments, the core network device is a first control-plane core network device, and accordingly, the processing unit 1410 is specifically configured to actively determine the first information of each of the plurality of data sets; or receive a request message from a second control-plane core network device; and determine the first information of each of the plurality of data sets in response to the request message.

In some embodiments, the request message is transmitted by the second control-plane core network device in response to determining that the network is in a congested state.

In some embodiments, the request message includes a type of the first information.

In some embodiments, the request message further includes an identifier of the first control-plane core network device.

In some embodiments, the first control-plane core network device is a trusted or untrusted control-plane core network device.

In some embodiments, in the case that the first control-plane core network device is an untrusted control-plane core network device, the first information of each of the plurality of data sets is forwarded to the access network device upon being authenticated and authorized by the third control-plane core network device.

In some embodiments, the first control-plane core network device is an AF, the second control-plane core network device is an SMF, and the third control-plane core network device is an NEF.

In some embodiments, the first information of each data set includes any of: a type of the data set, an importance level of the data set, a period of a data set sequence to which the data set belongs, or a data size of the data set.

In some embodiments, each data set includes video frames or coded slices.

In some embodiments, in some embodiments, the communication unit described above is a communication interface or a transceiver, or a communication chip or an input/output interface of a system-on-chip. The processing unit described above includes one or more processors.

It should be understood that the core network device according to embodiments of the present disclosure corresponds to the core network device in the method embodiments, and the above and other operations and/or functions of the various units in the core network device are respectively to achieve the corresponding processes of the core network device in the method embodiments, which are not repeated herein for brevity.

FIG. 15 is a schematic diagram of an access network device 1500 according to some embodiments of the present disclosure. As shown in FIG. 15, the access network device 1500 includes a communication unit 1510 and a processing unit 1520. The communication unit 1510 is configured to receive first information of each of a plurality of data sets from a core network device. The processing unit 1520 is configured to determine importance and/or an association relationship of the plurality of data sets based on the first information of each of the plurality of data sets and schedules air interface resources based on the importance and/or the association relationship of the plurality of data sets.

In some embodiments, the first information of each of the plurality of data sets is determined by the core network device based on application layer packet header information of each of the plurality of data sets.

In some embodiments, the application layer packet header information of each data set includes the first information for the data set.

In some embodiments, the user-plane core network device is a UPF.

In some embodiments, the core network device is a first control-plane core network device. The first information of each of the plurality of data sets is actively determined by the first control-plane core network device or determined by the first control-plane core network device in response to a request message transmitted by the second control-plane core network device.

In some embodiments, the request message is transmitted by the second control-plane core network device in response to determining that the network is in a congested state.

In some embodiments, the request message includes a type of the first information.

In some embodiments, the request message further includes an identifier of the first control-plane core network device.

In some embodiments, the first control-plane core network device is a trusted or untrusted control-plane core network device.

In some embodiments, in the case that the first control-plane core network device is an untrusted control-plane core network device, the first information of each of the plurality of data sets is forwarded to the access network device upon being authenticated and authorized by the third control-plane core network device.

In some embodiments, the first control-plane core network device is an AF, the second control-plane core network device is an SMF, and the third control-plane core network device is an NEF.

In some embodiments, the first information of each data set includes any of: a type of the data set, an importance level of the data set, a period of a data set sequence to which the data set belongs, or a data size of the data set.

In some embodiments, each data set includes video frames or coded slices.

In some embodiments, the processing unit 1520 is specifically configured to determine importance and/or an association relationship of the plurality of data sets based on priori information and the first information of each of the plurality of data sets.

In some embodiments, the priori information is predefined, configured by the access network device, or configured by any other core network device.

In some embodiments, the processing unit 1520 is specifically configured to determine a data set with importance higher than a predefined importance among the plurality of data sets, and prioritizing schedule air interface resources to the data set with importance higher than a predefined importance among the plurality of data sets; and/or, the processing unit 1520 is configured to determine a reference data set of a target data set based on the association relationship of the plurality of data sets, determine a transmission situation of the reference data set, and discard the reference data set and/or the target data set upon determining, based on the transmission situation of the reference data set, that the reference data set fails to be transmitted correctly.

In some embodiments, in some embodiments, the communication unit described above is a communication interface or a transceiver, or a communication chip or an input/output interface of a system-on-chip. The processing unit described above includes one or more processors.

It should be understood that the access network device according to some embodiments of the present disclosure corresponds to the access network device in the method embodiments, and that the above and other operations and/or functions of the various units in the access network device are respectively intended to achieve the corresponding processes of the access network device in the method embodiments, which are not repeated herein for brevity.

FIG. 16 is a schematic diagram of a core network device 1600 according to some embodiments of the present disclosure. The core network device 1600 is a second control-plane core network device. As shown in FIG. 16, the core network device 1600 includes a communication unit 1610 configured to transmit a request message to a first control-plane core network device. The request message is configured to trigger the first control-plane core network device to determine first information of each of a plurality of data sets. The first information of each of the plurality of data sets is configured to determine importance and/or an association relationship of the plurality of data sets, such that the access network device is capable of scheduling air interface resources based on the importance and/or the association relationship of the plurality of data sets.

In some embodiments, the request message is transmitted by the second control-plane core network device in response to determining that the network is in a congested state.

In some embodiments, the request message includes a type of the first information.

In some embodiments, the request message further includes an identifier of the first control-plane core network device.

In some embodiments, in some embodiments, the communication unit is a communication interface or a transceiver, or a communication chip or an input/output interface of a system-on-chip.

It should be understood that the core network device according to some embodiments of the present disclosure corresponds to the second core network device in the method embodiment, and the above and other operations and/or functions of the various units in the core network device are respectively intended to achieve the corresponding processes of the second core network device in the method embodiment, which are not repeated herein for brevity.

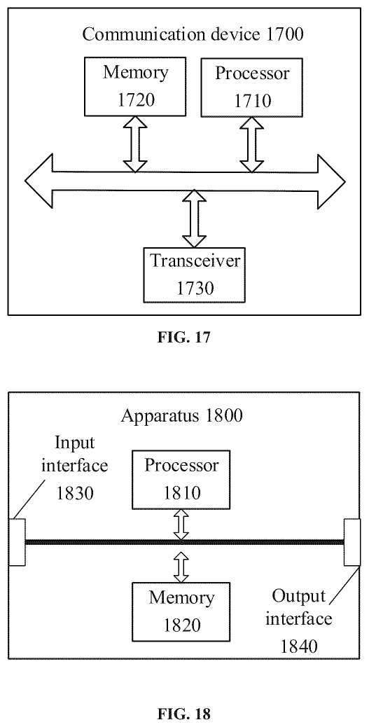

FIG. 17 is a schematic structural diagram of a communication device 1700 according to some embodiments of the present disclosure. The communication device 1700 shown in FIG. 17 includes a processor 1710. The processor 1710, when loading and running at least one computer program from a memory, is caused to perform the method according to the embodiments of the present disclosure.

In some embodiments, as shown in FIG. 17, the communication device 1700 further includes a memory 1720. The processor 1710, when loading and running at least one computer program from the memory 1720, is caused to perform the method according to the embodiments of the present disclosure.

The memory 1720 is a device separate from the processor 1710, or is integrated into the processor 1710.

In some embodiments, as shown in FIG. 17, the communication device 1700 further includes a transceiver 1730, which is controlled by the processor 1710 to communicate with other devices, specifically, to transmit information or data to other devices or to receive information or data from other devices.

The transceiver 1730 includes a transmitter and a receiver. The transceiver 1730 further includes one or more antennas.

In some embodiments, the communication device 1700 is specifically a network device in some embodiments of the present disclosure, and the communication device 1700 performs the corresponding processes performed by the network device in the various methods according to the embodiments of the present disclosure, which may not be repeated herein for brevity.

In some embodiments, the communication device 1700 is specifically a terminal device in some embodiments of the present disclosure, and the communication device 1700 performs the corresponding processes performed by the terminal device in the various methods according to the embodiments of the present disclosure, which may not be repeated herein for brevity.

FIG. 18 is a schematic structural diagram of an apparatus according to some embodiments of the present disclosure. The apparatus 1800 shown in FIG. 18 includes a processor 1810. The processor 1810, when loading and running at least one computer program from a memory, is caused to perform the method according to the embodiments of the present disclosure.

In some embodiments, as shown in FIG. 18, the apparatus 1800 further includes a memory 1820. The processor 1810, when loading and running at least one computer program from the memory 1820, is caused to perform the method according to the embodiments of the present disclosure.

The memory 1820 is a device separate from the processor 1810, or is integrated into the processor 1810.

In some embodiments, the apparatus 1800 further includes an input interface 1830. The processor 1810 controls the input interface 1830 to communicate with other devices or chips, specifically, to acquire information or data transmitted by other devices or chips.

In some embodiments, the apparatus 1800 further includes an output interface 1840. The processor 1810 controls the output interface 1840 to communicate with the other device or chip, specifically, to output information or data to the other device or chip.

In some embodiments, the apparatus is applicable to a network device in the embodiments of the present disclosure, and the apparatus performs the corresponding processes performed by the network device in the various methods according to the embodiments of the present disclosure, which may not be repeated herein for brevity.

In some embodiments, the apparatus is applicable to a terminal device in the embodiments of the present disclosure, and the apparatus performs the corresponding processes performed by the terminal device in the respective methods according to the embodiments of the present disclosure, which may not be repeated herein for brevity.

In some embodiments, the apparatus referred to in the embodiments of the present disclosure is also a chip, such as a system-level chip, a system chip, a chip system, or a system-on-chip.

It should be understood that the processor according to the embodiments of the present disclosure is an integrated circuit chip with signal processing capabilities. In implementation, the processes of the method embodiments described above may be accomplished by integrated logic circuits of hardware in the processor or instructions in the form of software. The above-described processor may be a general-purpose processor, a digital signal processor (DSP), an application-specific integrated circuit (ASIC), a field-programmable gate array (FPGA) or other programmable logic device, a discrete gate or transistor logic device, or a discrete hardware component. Various methods, processes, and logic block diagrams according to the embodiments of the present disclosure may be implemented or performed. The general purpose processor may be a microprocessor or any conventional processor. The processes of the methods disclosed in conjunction with the embodiments of the present disclosure may be directly embodied in being performed by a hardware decoding processor, or performed by a combination of hardware and software modules in the decoding processor. The software module may be disposed in a random memory, a flash memory, a read-only memory (ROM), a programmable read-only memory (PROM), an electrically erasable programmable memory, a register, or other storage medium well established in the art. The storage medium is disposed in a memory, and the processor reads the information in the memory to perform the processes of the above method in conjunction with its hardware.

It should be appreciated that the memory in the embodiments of the present disclosure may be volatile or non-volatile, or may include both volatile and non-volatile memories. The non-volatile memory may be a ROM, a PROM, an erasable programmable read-only memory (EPROM), an electrically EPROM (EEPROM), or a flash memory. The volatile memory may be a random access memory (RAM), which is used as an external cache. By way of illustration but not limitation, many forms of RAM are available, such as a static RAM (SRAM), a dynamic RAM (DRAM), a synchronous DRAM (SDRAM), a double data rate SDRAM (SDRAM), an enhanced SDRAM (ESDRAM), a synchronous link DRAM (SLDRAM), or a direct rambus RAM (DR RAM). It should be noted that the memory of the system and method described herein is intended to include, but is not limited to, these and any other suitable types of memory.

It should be understood that the above memories are exemplary but not limiting descriptions. For example, the memory in the embodiments of the present disclosure may also be an SRAM, a DRAM, an SDRAM, a DDR SDRAM, an ESDRAM, an SLDRAM, or a DR RAM. That is, the memory in the embodiments of the present disclosure is intended to include, but is not limited to, these and any other suitable types of memory.

Some embodiments of the present disclosure further provide a computer-readable storage medium for storing at least one computer program.

In some embodiments, the computer-readable storage medium is applicable to the network device or base station in the embodiments of the present disclosure, and the at least one computer program causes the computer to perform the corresponding process performed by the network device or the base station in the various methods according to the embodiments of the present disclosure, which may not be repeated herein for brevity.

In some embodiments, the computer-readable storage medium is applicable to the mobile terminal/terminal device in the embodiments of the present disclosure, and the at least one computer program causes the computer to perform the corresponding processes performed by the mobile terminal/terminal device in the respective methods according to the embodiments of the present disclosure, which may not be repeated herein for brevity.

Some embodiments of the present disclosure further provide a computer program product including at least one computer program instruction.

In some embodiments, the computer program product is applicable to the network device or base station in the embodiments of the present disclosure, and the at least one computer program instruction causes the computer to perform the corresponding processes performed by the network device or the base station in the various methods according to the embodiments of the present disclosure, which may not be repeated herein for brevity.

In some embodiments, the computer program product is applicable to the mobile terminal/terminal device in the embodiments of the present disclosure, and the at least one computer program instruction causes the computer to perform the corresponding processes performed by the mobile terminal/terminal device in the methods according to the embodiments of the present disclosure, which may not be repeated herein for brevity.

Some embodiments of the present disclosure further provide a computer program.

In some embodiments, the computer program is applicable to the network device or base station in the embodiments of the present disclosure, and the computer program, when loaded and run on a computer, causes the computer to perform the corresponding processes performed by the network device or the base station in the various methods according to the embodiments of the present disclosure, which may not be repeated herein for brevity.

In some embodiments, the computer program is applicable to the mobile terminal/terminal device in the embodiments of the present disclosure, and the computer program, when loaded and run on a computer, causes the computer to perform the corresponding processes performed by the mobile terminal/terminal device in the various methods according to the embodiments of the present disclosure, which may not be repeated herein for brevity.

Those skilled in the art should realize that the units and algorithmic processes described in conjunction with the various examples of the embodiments disclosed herein are capable of being implemented in electronic hardware, or a combination of computer software and electronic hardware. Whether these functions are performed in hardware or software depends on the particular application and design constraints of the technical solution. Those skilled in the art may use different methods to implement the described functions for each particular application, but such implementations should not be considered outside the scope of the present disclosure.

Those skilled in the art may clearly understand that for the convenience and brevity of description, the specific operating processes of the systems, apparatuses, and units described above may refer to the corresponding processes in the above embodiments of the methods, which are not described herein.

In the embodiments of the present disclosure, it should be understood that the disclosed systems, apparatuses, and methods may be implemented in other ways. For example, the apparatuses embodiments described above are merely schematic. For example, the division of the units are only division based on logical functions. There may be other division modes during the actual implementation. For example, a plurality of units or components may be combined or may be integrated into another system, or some features may be ignored, or not implemented. In addition, the mutual coupling or direct coupling or communication connection as shown or discussed may be an indirect coupling or communication connection through some interfaces, apparatuses, or units, which may be electrical, mechanical, or other forms.

The units described as separated components may be or may not be physically separated, and components shown as units may be or may not be physical units, i.e., they may be disposed in one place or may be distributed on a plurality of network units. Part or all of these units may be selected to achieve the purpose of the embodiments according to actual needs.

Alternatively, the functional units in various embodiments of the present disclosure may be integrated into one processing unit, or each unit may be physically present separately, or two or more units may be integrated into one unit.

The functionality may be stored in a computer-readable storage medium in the case that the functionality is implemented as a software functional unit and sold or used as a separate product. It should be understood that the essence of the technical solutions of present disclosure, the part that contributes to the related art, or the part of the technical solutions may be embodied in the form of a software product. The computer software product is stored in a storage medium including several instructions to cause a computer device (which may be a personal computer, a server, or a network device) to perform all or some of the processes of the method described in the various embodiments of the present disclosure. The storage medium includes a USB flash drive, a removable hard disk, an ROM, an RAM, a diskette, a CD-ROM, or other medium that stores program codes.

Described above are exemplary embodiments of the present disclosure, but the protection scope of the present disclosure is not limited to these exemplary embodiments. Various variations or substitutions readily conceivable by those skilled in the art within the technical scope disclosed in the present disclosure shall fall within the protection scope of the present disclosure. Therefore, the protection scope of the present disclosure should be subjected to the appended claims.

1. A method for wireless communication, applicable to a core network device, the method comprising:
determining first information of each of a plurality of data sets; and
transmitting the first information of each of the plurality of data sets to an access network device;
wherein the first information of each of the plurality of data sets is configured to determine importance and/or an association relationship of the plurality of data sets, such that the access network device is capable of scheduling air interface resources based on the importance and/or the association relationship of the plurality of data sets.

2. The method according to claim 1, wherein:
the core network device is a user-plane core network device; and
determining the first information of each of the plurality of data sets comprises:
determining the first information of each of the plurality of data sets based on application layer packet header information of each of the plurality of data sets.

3. The method according to claim 2, wherein the application layer packet header information of each of the plurality of data sets comprises the first information of the each of the plurality of data sets.

4. The method according to claim 2, wherein prior to transmitting the first information of each of the plurality of data sets to the access network device, the method further comprises:
adding the first information of each of the plurality of data sets to a packet header other than an Internet Protocol (IP) packet header of the each of the plurality of data sets.

5. The method according to claim 4, wherein adding the first information of each of the plurality of data sets to the packet header other than the IP packet header of the each of the plurality of data sets comprises:
adding the first information of the each of the plurality of data sets to a general packet radio service (GPRS) Tunneling Protocol (GTP) packet header of the each of the plurality of data sets.

6. The method according to claim 2, wherein the user-plane core network device is a user-plane function (UPF).

7. The method according to claim 1, wherein:
the core network device is a first control-plane core network device; and
determining the first information of each of the plurality of data sets comprises:
actively determining the first information of each of the plurality of data sets; or
receiving a request message from a second control-plane core network device, and determining the first information of each of the plurality of data sets in response to the request message.

8. The method according to claim 1, wherein the first information of each of the plurality of data sets comprises any one of: a type of the each of the plurality of data sets, an importance level of the each of the plurality of data sets, a period of a data set sequence to which the each of the plurality of data sets belongs, or a data size of the each of the plurality of data sets.

9. The method according to claim 1, wherein each of the plurality of data sets comprises a video frame or a coded slice.

10. A core network device, comprising:
a processor; and
a memory storing at least one computer program, which when executed by the processor, causes the core network device to:
determine first information of each of a plurality of data sets; and
transmit the first information of each of the plurality of data sets to an access network device;
wherein the first information of each of the plurality of data sets is configured to determine importance and/or an association relationship of the plurality of data sets, such that the access network device is capable of scheduling air interface resources based on the importance and/or the association relationship of the plurality of data sets.

11. The core network device according to claim 10, wherein:
the core network device is a user-plane core network device; and
the at least one computer program, which when executed by the processor, further causes the core network device to:
determine the first information of each of the plurality of data sets based on application layer packet header information of each of the plurality of data sets.

12. The core network device according to claim 11, wherein the application layer packet header information of each of the plurality of data sets comprises the first information of the each of the plurality of data sets.

13. The core network device according to claim 11, wherein prior to transmitting the first information of each of the plurality of data sets to the access network device, the processor, when loading and running the at least one computer program stored in the memory, is caused to further perform:
adding the first information of each of the plurality of data sets to a packet header other than an Internet Protocol (IP) packet header of the each of the plurality of data sets.

14. An access network device, comprising:
a processor; and
a memory storing at least one computer program, which when executed by the processor, causes the access network device to:
receive first information of each of a plurality of data sets from a core network device;
determine importance and/or an association relationship of the plurality of data sets based on the first information of each of the plurality of data sets; and
schedule air interface resources based on the importance and/or the association relationship of the plurality of data sets.

15. The access network device according to claim 14, wherein the core network device is a user-plane core network device, and the first information of each of the plurality of data sets is determined by the core network device based on application layer packet header information of each of the plurality of data sets.

16. The access network device according to claim 15, wherein the application layer packet header information of each of the plurality of data sets comprises the first information of the each of the plurality of data sets.

17. The access network device according to claim 15, wherein the first information of each of the plurality of data sets is added by the core network device to a packet header other than an Internet Protocol (IP) packet header of the each of the plurality of data sets.

18. The access network device according to claim 17, wherein the first information of each of the plurality of data sets is added by the core network device to a general packet radio service (GPRS) Tunneling Protocol (GTP) packet header of the each of the plurality of data sets.

19. The access network device according to claim 15, wherein the user-plane core network device is a user-plane function (UPF).

20. The access network device according to claim 14, wherein the first information of each of the plurality of data sets comprises any one of: a type of the each of the plurality of data sets, an importance level of the each of the plurality of data sets, a period of a data set sequence to which the each of the plurality of data sets belongs, or a data size of the each of the plurality of data sets.
